(19) United States
(12) Patent Application Publication
(10) Pub. No.: US 2017/0270131 A1
(43) Pub. Date: Sep. 21, 2017

(54) SYNCHRONIZATION AND MANAGEMENT OF HETEROGENEOUS HOST DIRECTORIES IN A SECURITY ENVIRONMENT

(71) Applicant: Conjur, Inc., Waltham, MA (US)

(72) Inventors: Josh Bregman, Weston, MA (US); Kevin Gilpin, Weston, MA (US)

(21) Appl. No.: 15/462,020

(22) Filed: Mar. 17, 2017

Related U.S. Application Data
(60) Provisional application No. 62/310,521, filed on Mar. 18, 2016.

(51) Int. Cl. G06F 17/30; H04L 29/06

(52) U.S. Cl. CPC G06F 17/30091; H04L 63/10; H04L 63/0428; H04L 63/06; G06F 17/30144; G06F 17/30174; G06F 17/30194; G06F 2221/2151

(57) ABSTRACT

Systems, methods, apparatus, computer readable media and other implementations provide host directory synchronization and management in which a master host directory system constructs, maintains and updates a master host list of all hosts that are identified and managed by constituent host directory systems in a computing environment. The master host directory system obtains host data from the constituent host directory systems through encrypted file transfers between the master and constituent host directory systems. In addition to creating and maintaining the master list of host identities, the master host directory system can also assist in defining and enforcing security measures affecting host creation, operation, updating and termination.

### RELATED APPLICATIONS

This application hereby claims the benefit of and priority to the following, which is incorporated by reference in its entirety (including any appendices thereto): U.S. Provisional Patent Application 62/310,521, entitled “SYNCHRONIZATION AND MANAGEMENT OF HETEROGENEOUS HOST DIRECTORIES IN A SECURITY ENVIRONMENT,” filed 18 Mar. 2016 (Attorney Docket No. 716.0012P1).

### TECHNICAL FIELD

Aspects of the disclosure are related to the field of access control in computing environments.

### TECHNICAL BACKGROUND

In many environments (including environments in which security is enforced by permissions, keys, passwords and other measures) computer record-keeping and management may be implemented and maintained by a variety of systems or applications and/or on a variety of apparatus, including those that maintain and update host directories. Such environments thus possess heterogeneous host directory systems that are responsible for defining, enforcing and updating security measures, as well as host identification data and other important operational aspects of the computing systems in the environment with which they are affiliated. Many organizations, enterprises and other groups that utilize a number of computing systems have acquired these heterogeneous systems through acquisition of different computing systems, implementation of different applications and systems, different geographic locations that provide different product and service offerings, etc. Notwithstanding the differences between a given organization's various computing systems, such an organization or enterprise nevertheless needs to implement consistent policies, procedures and other measures to ensure consistent management and security throughout the interrelated systems.

### OVERVIEW

Implementations described herein provide systems, methods, apparatus, computer readable media and other implementations that provide host directory synchronization and management in which a master host directory system constructs, maintains and updates an inventory or census of all hosts that are identified and managed by constituent host directory systems in a given computing environment. The master host directory system obtains host data from the constituent host directory systems through encrypted file transfers between the master and constituent host directory systems in some implementations. In addition to creating and maintaining a master list of host identities, the master host directory system can also assist in defining and enforcing security measures affecting host creation, operation, updating and termination.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a computing environment.

FIG. 2 illustrates a computing environment controlling access to protected assets and/or resources.

FIG. 3 illustrates one or more methods of providing host directory synchronization and management in a computing environment.

FIG. 4 illustrates a computing system configured to implement and/or participate in host directory synchronization and management according to one or more implementations.

### DETAILED DESCRIPTION

The various figures and descriptions included herein discuss non-limiting examples of enhanced host directory synchronization and management in a computing environment, especially environments in which multiple heterogeneous host directories and/or host directory systems are in use. In some implementations of host directory synchronization and management, a master host directory system is configured to periodically collect host data (e.g., in real time, on a preset schedule, when a constituent host directory system notifies the master host directory system) from each of a plurality of constituent host directory systems that are part of an organizational computing environment. The host data can comprise host identification data, host metadata and directory structure data that allows the master host directory system to replicate the essential data, structure and other characteristics of each constituent host directory system and to create, maintain and update an encyclopedic host directory for the computing environment. Host directories across heterogeneous systems and environments (e.g., elastic cloud environments) are useful where certain applications and/or functionalities are used (e.g., remote secure key storage, management and operations relating to various users, hosts, etc.).

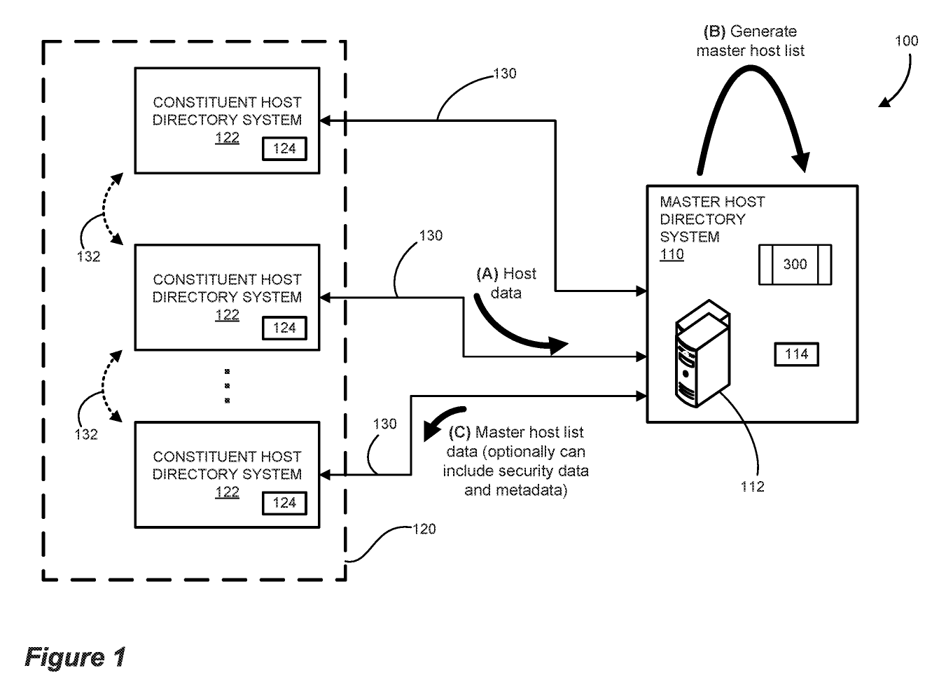

As seen in FIG. 1, a computer environment 100 includes a master host directory system 110 and an organization or other collection of computers and/or computing systems 120 that includes a number of constituent host directory systems 122. connected to master host directory system 110 by links 130. Other links 132 within collection 120 may permit constituent host directory systems 122 to communicate directly with one another. Communications sent between master host directory system 100 and the various constituent host directory systems 122 can be encrypted appropriately (e.g., using encryption modules 124 in systems 122 and encryption module 114 in system 110). Depending on the environment 100, an appropriate system of record for hosts can be selected. A wide range of environments can be serviced if multiple host systems are able to synchronize hosts. For example, system 110 can be (or be part of) a platform for directory services, authorization and audit for development and operations.

For example, such systems can implement SSH access management, secrets management, service-to-service authorization and/or other functionalities. This type of system can be run in a virtual machine or container, working alongside a wide range of identity and access management (IAM) solutions addressing issues such as machine-to-machine permissions, deployment and access rights to sensitive systems, and the auditing required to meet compliance requirements. This permits these types of systems to be created, de-provisioned and changed in real time, adapting to and mitigating security risks and meeting compliance requirements without slowing down their continuous integration workflows, and keeping secrets, keys, certificates, and authorization data out of repositories and off hard drives.

Non-limiting examples of uses further include compliance (e.g., for auditable enforcement of both organizational and regulatory policies and rules, in instances via existing reporting systems (e.g., STEM platforms, SumoLogic, Splunk)), risk management (e.g., to reduce the attack surface for sensitive data (credentials, SSL/SSH keys and certificates, secrets, etc.) via a policy and governance platform), DevOps optimization (e.g., integrating security and controls in upstream development and operations work, ensuring consistency across all production systems), and access intelligence (unifying control of both human and machine identities, as well as permissions across entire infrastructures (bare metal, private, public, cloud) to help prevent failures, without relying on legacy systems for policy governance and enforcement). There are various specific architectures that can implement one or more of these functions and/or capabilities.

System 110 can be implemented as one or more servers operating on one or more local databases. System 110 can expose an application programming interface (API) for authentication, permissions management, permissions checks, manipulation of secrets and access to an audit trail. This can be provided alongside support for legacy lightweight directory access protocol over SSL (LDAPS). This combination can expose directory capabilities to facilitate utilization of system 110 by various systems that can be configured to work with LDAP.

Sensitive data can be saved in an encrypted state at rest, protected by a separately stored master key. Communication with other parties can be conducted over SSL or in some other secure manner. Authentication deals primarily with confirming a user's identity. System 110 and environment 100 can support human identities (“users”) as well as identities for virtual machines, processes and jobs (some or all of the non-human identities can be referred to as “hosts”).

A “host” as used herein can thus be a computer or generally any computing node or apparatus in a computing environment (e.g., on a network) that has its own internet protocol UP) address and/or domain name. A computer can be any kind of computer, such as general purpose computer, physical machine, virtual machine, container, application, desktop computer, tablet, cellular device, smartphone, mobile computer, laptop computer, server computer, embedded system, mainframe, mobile device, cluster of computers, a distributed computer, or another type of computing system. Some hosts may be permanent within a given system, while other hosts may have predefined or dynamic terminations over time, being spun up and exist only when and while needed, thereafter being removed from the system in which they operate.

Operations such as permissions and/or secrets management and permission checks can be logged automatically in an audit trail. Moreover, customized records can be generated and logged as part of the audit trail in system 110 and environment 100.

As explained in more detail elsewhere, “authorization” controls access to resources in a given setting. Rules governing such access can be created and applied by administrators and/or others. Every user and host can possess specific permissions based on his/her/its roles) and the permissions granted to such role(s). Admins and/or the like can set up permissions models (e.g., creating user and host identities, organizing users into groups, organizing hosts into layers, granting permissions between users, hosts and resources). User and host directories can be imported from various sources, as discussed herein.

System 110 can be configured as a high-availability system having a master server system that handles directory and audit records, manages permission update operations and hosts a root SSL certificate that can be used to sign followers' certificates. It may also include a standby master that is a read-only replica of the master server system's records, thus being capable of replacing the master server system when necessary, One or more follower servers can perform read-only functions such as permission checks, public key distribution, and secrets access. Such followers can ship accounting records back to the master server system via out-of-band communication.

Non-limiting examples of master-follower implementations can include global distribution (e.g., across availability zones, regions and clouds), low latency (achieved with proximally located followers), high availability (through automated and/or manual failover capabilities), and cloud-friendly network architecture. Provisioning of high availability components can be done in various ways (e.g., AWS CloudFormation templates, or custom scripts on platforms different than AWS). As part of the follower provisioning process, a new follower can connect to a master using an SSH key provided as a provisioning parameter. Once connected, the new follower obtains initialization data from the master, and finishes configuring any services. As SSL certificate for the follower can be created and signed by the master, then installed on the follower (and can include environment-specific host names used by client virtual machines to talk to system 110). The root SSL certificate resides only on the master (and any standby maker), not on followers (thus followers cannot be promoted to masters in such exemplary systems).

These types of systems can be deployed into a wide variety of platforms, including but not limited to: Amazon EC2, Amazon VPC, Microsoft Azure, and bare metal servers. Moreover, high availability architecture components can be deployed across different clouds, if needed, assuming appropriate audit transport and replication capabilities are available between followers and any master(s). A command-line toolset can be used for interaction with system 110, where the CLI can be considered a primary tool for system management and operation.

As noted above, specific applications for which host directory synchronization and management is provided by a master host directory system that constructs, maintains and updates a host inventory or census can include SSH access management, secrets management and service-to-service authorization. In SSH access management applications, implementations of the master host directory can be part of standards-based SSH access to cloud servers and virtual machines, providing both authentication (e.g., public keys do not need to be physically copied or otherwise distributed to each server or virtual machine because system 110 can make public keys available to SSH dynamically at login time) and authorization of SSH login (e.g., during authorization the login system determines if an authenticated user should be granted access and at what level, for example based on role). A server to which SSH access is granted can be provisioned to use an authentication and authorization provider and thus be assigned a host identity. To gain SSH access to a server, a user can have a user identity registered with a personal public key, use an appropriate personal SSH key that matches the registered public key, thereafter being allowed access to a target host with an appropriate level of privileges based on group membership and/or other role-based criteria).

Secrets management using implementations disclosed herein can avoid earlier security risks (e.g., compromising secrets via access to server file systems or a snapshot thereof, tracking who accesses secret data and detailed permissions control over it). Instead, secrets can be stored in an encrypted, access-controlled container on a system server, thus providing centralized manipulation of secrets with a comprehensive audit trail. Various hosts included in the master directory can be authorized to participate in secrets functions (e.g., fetching secrets to make them available to calling scripts).

In implementations pertaining to service-to-service authorization, some services can be restricted from talking to other services and auditing of (successful and unsuccessful) attempts to do so can be implemented, for example by using role-based access control (RBAC) capabilities. Any service instance that needs to call other services can be assigned a host identity, which may be created in a constituent host directory system 122 and thereafter included in the master host directory constructed by the master directory system 110. Host and layer access to other hosts and layers can be defined by a permissions model so that outgoing service calls are performed through an authentication proxy or the like. Protected services can be mapped to the authentication proxy so that a permission check can determine whether or not the request should be allowed.

A master host directory system can be part of a broader authentication and authorization system or the like. For example, in some implementations, an authorization engine can perform a variety of functions based on role-based access control, including (without limitation) (1) creation and maintenance of authorization rules, and (2) enforcing privilege-based access to resources by users and the like (also referred to as transaction control that is role-based—for example, where an RBAC “transaction” includes three parts: a role, a privilege, and a resource). Non-limiting examples of this type may be used to help illustrate implementations of enhanced host directory synchronization and management in a computing environment herein. A “role” identifies the subject: who or what is acting. This can be a specific identity such as a user or machine (including a virtual machine), or a generic group identity. A role possesses privileges and is authorized to initiate transactions. Again, a role may represent a person, a group, a non-human user (“robot”) such as a virtual machine or process, or a group of other roles. Resources are entities (e.g., a protected asset, such as a database, service and/or an encrypted secret) on which permissions are defined.

In addition to having privileges, a role can be granted to another role. When a role is granted, the receiving role can gain all the privileges of the granted role. The receiving role (e.g., an individual) gains all the roles that are held by the new role; thus, role grants can be fully inherited. If a user or other role attempts a transaction, that transaction will be allowed if the user or any inherited role(s) has the required privilege.

System 110 can control resource access of various types. For example, “reading” a resource may be a permission to show record attributes. “Executing” can be permission to invoke the record (e.g., fetching the value of a secret, SSH login to a host, invoking a web service endpoint function). “Updating” can be permission to modify a record (e.g., modifying the value of a secret, SSH login to a host with elevated privileges).

In one non-limiting example, RBAC can be implemented in SSH management, allowing certain users/roles access to SSH to a server defined by permission to either execute or update a host (or all hosts in a given layer). Such permission to act can be interpreted not as a permission on a layer resource, but rather as a permission on all hosts in the layer. Thus host data in the master directory of system 110 can include layer information as well.

Collection of host data from constituent host directory systems 122 in some implementations can include directory synchronization that includes importing Active Directory or POSIX LDAP structure into the master directory system. It can extract identities from an existing constituent directory server to be incorporated into the master directory system's infrastructure (e.g., a security infrastructure). Master host directory system 110 can recognize and assimilate LDAP naming conventions and the like so that hosts, users and groups can be manipulated and managed. The connection between the master host directory system 110 and each constituent host directory system 122 can be a read-only connection to an LDAP server, so that directory-management functions and modifications have no effect on the original LDAP database or host/user information. Specified changes or adjustments to an original LDAP naming model can be integrated into the master host directory system 110 with each new synchronization. The sync can retain LDAP-hierarchical information about hosts, layers, groups and/or members. Even though synchronization may be performed using a read-only connection with each constituent host directory system 122, the master host directory system 110 may nevertheless provide one or more of the constituent host directory systems 122 with master host directory data (e.g., security data, metadata). The connection and configuration of the master host directory system 110 synchronization process with each constituent host directory system 122 can be set up using a user interface or the like that establishes the type of connection (e.g., encrypted), addressing, relevant fields, etc.

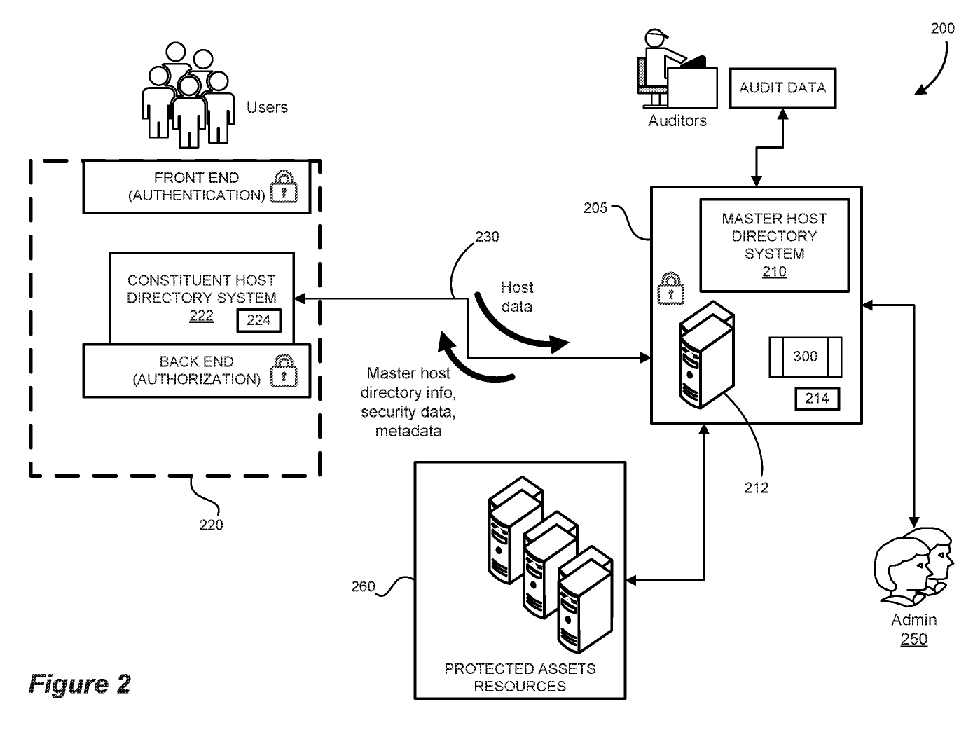

A non-limiting example of an environment implementing host directory synchronization and management in which a master host directory system is utilized is shown in FIG. 2. Environment 200 includes a master server system 205 connected to a constituent computing system 220. Constituent computing system 220 can include a constituent host directory system 222, as well as front end and back end functionalities relating to authentication and authorization functions. Constituent host directory system 222 can utilize an encryption module 224 for communications between system 222 and a master host directory system 210 located in master system 205 (which can also utilize an encryption module 214 or the like). Master system 205 collects and maintains audit data 240 and can be accessed by administrators 250 and the like. Master host directory system 210 and master system 205 assist in controlling access to protected assets 260 (e.g., resources). Using one or more implementations of host directory synchronization and management, master system 205 can receive host data from constituent host directory system 222 and likewise send it master host directory information (e.g., including security data and metadata).

Files can be used to exchange relevant host information. A master host directory system acting as a host-synchronization component can read files from an input directory and write files to an output directory. In FIG. 1 master host directory system 110 can access each constituent host directory system 122 using the same private key for a secure shell (SSH) or other appropriate connection. As part of the setup of environment 100, the master host directory system and constituent host directory systems can agree on a common private/public key pair that the master host directory system can use to securely connect to a given entity to perform host directory synchronization and management as described herein. Master host directory system 110 can then obtain host data from each constituent host directory system 122 and construct a master list of the hosts on all participating constituent host directory systems 122.

Each constituent host directory system 122 can use a command line interface (CLI) to generate its local host list, then convert it to suitably formatted host data files (e.g., YAML) that permits easy mapping of data relating to lists, associative arrays and scalars and hierarchical data representations. The constructed host data files can then be transmitted to the master host directory system 110 securely (e.g., using a secure copy (SCP) transfer).

Each host data file can comprise a list including the name of the host and SSH connection information (e.g., user@host). Each file can also comprise metadata and/or other information about a given host that is included in the host data file and is used by the master host directory system 110 to construct a master host list. For example, there may be rules, permissions, operating limits and termination information about a given host that limits its operation and/or existence. If a given host is a temporary instantiation of an application or virtual machine, the master host directory system 110 can assist the constituent host directory system 122 responsible for managing that host in ensuring that the host is not viable beyond its required shut-down point and, once it is shut down, that it is not resurrected in an unauthorized manner.

If a host corresponding to host data obtained from a constituent host directory system does not exist on the master host directory system 110, that host is created and it can be enhanced with identification data, metadata and/or other information that is useful in synchronizing and managing the master host list and host activity in environment 100 in the future. After entries in the master host directory system 110 are created and/or updated, system 110 can then push updated information back out to the constituent host directory systems 122 and to the hosts they orchestrate to facilitate security enforcement and management in the future. Whenever a host entry is created or updated, a last-updated attribute (e.g., a timestamp) can be updated as well.

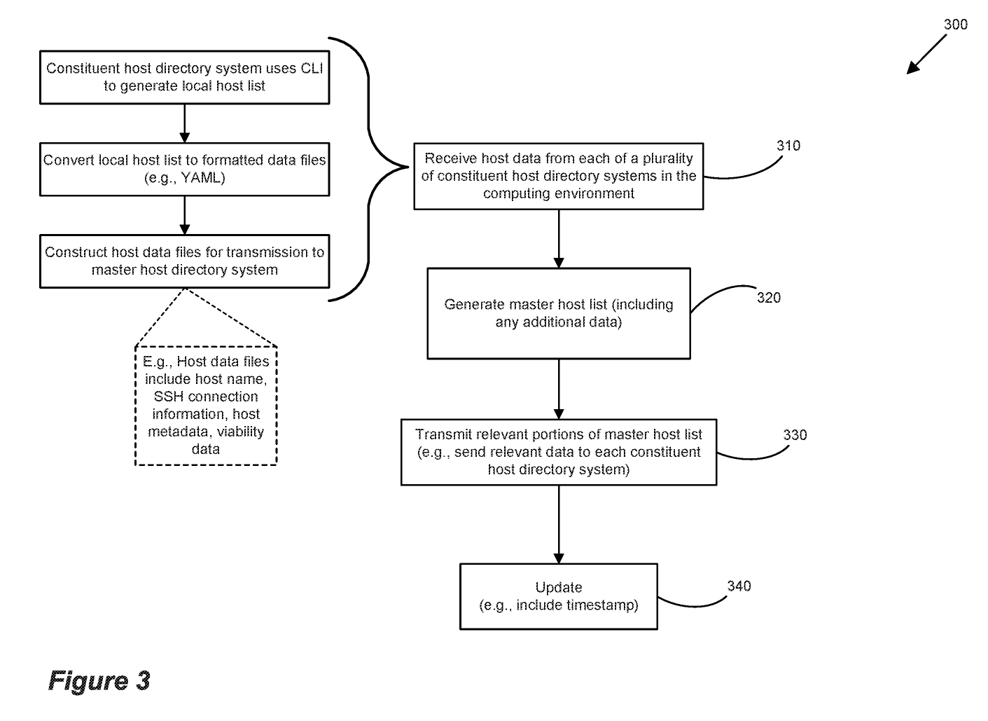

Referring to FIG. 3, a method 300 of providing host directory synchronization and management is shown. The master host directory system 110 receives host data (310) from each of a plurality of constituent host directory systems, wherein each constituent host directory system comprises a list of hosts connected to the computing environment. In some implementations, each constituent host directory system 122 can use a command line interface (CLI) to generate its local host list (312), then convert it to formatted data files (314), and then construct host data files to be transmitted to the master host directory system 110 securely (e.g., using a secure copy (SCP) transfer). The host data can comprise a name for each host and host connection information. The received host data is then processed to generate (320) a master host list. Relevant portions of the master host list are then transmitted (330) to the plurality of constituent host directory systems. These steps can be repeated to update the plurality of constituent host directory systems 122 as needed or desired (330).

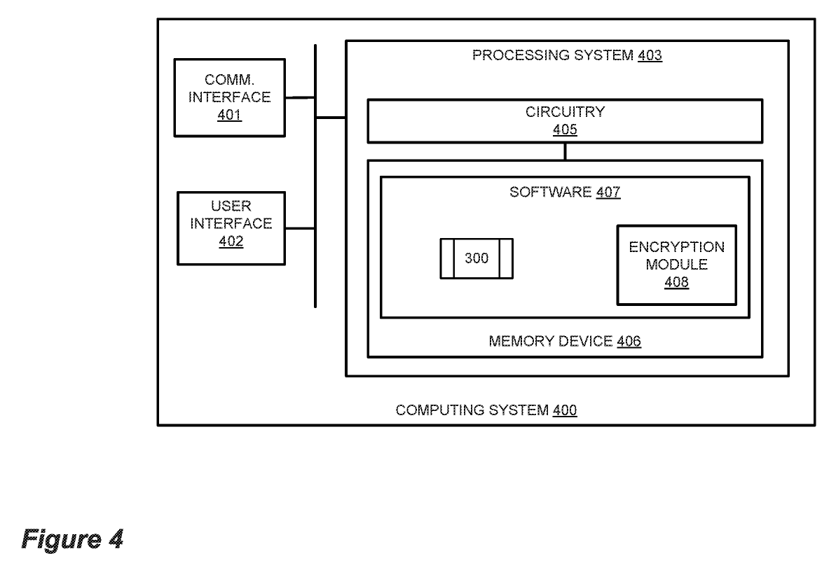

FIG. 4 illustrates a computing system 400 to provide host directory synchronization and management according to one or more implementations. Computing system 400 is representative of any computing system or systems with which the various operational architectures, processes, scenarios, and sequences disclosed herein for a processing environment may be implemented. Computing system 400 is an example of processing environment 100, constituent host directory systems 122, master host directory system 110, master system 205, and/or master host directory system 210, although other examples may exist. Computing system 400 may comprise one or more server computing systems, desktop computing systems, routers, gateways, switches, and other similar computing elements. Computing system 400 comprises communication interface 401, user interface 402, and processing system 403. Processing system 403 is linked to communication interface 401 and user interface 402. Processing system 403 includes processing circuitry 405 and memory device 406 that stores operating software 407.

Communication interface 401 comprises components that communicate over communication links, such as network cards, ports, radio frequency (RF) transceivers, processing circuitry and software, or some other communication devices. Communication interface 401 may be configured to communicate over metallic, wireless, or optical links. Communication interface 401 may be configured to use Internet Protocol (IP), Ethernet, Time Division Multiplex (TDM), optical networking, wireless protocols, communication signaling, or some other communication format—including combinations thereof. User interface 402 comprises components that interact with a user to receive user inputs and to present media and/or information. User interface 402 may include a speaker, microphone, buttons, lights, display screen, touch screen, touch pad, scroll wheel, communication port, or some other user input/output apparatus—including combinations thereof. User interface 402 may be omitted in some examples.

Processing circuitry 405 comprises microprocessor and other circuitry that retrieves and executes operating software 407 from memory device 406. Memory device 406 comprises a non-transitory storage medium, such as a disk drive, flash drive, data storage circuitry, or some other memory apparatus. Processing circuitry 405 is typically mounted on a circuit board that may also hold memory device 406 and portions of communication interface 401 and user interface 402. Operating software 407 comprises computer programs, firmware, or some other form of machine-readable processing instructions. Operating software 407 includes encryption module 408, although any number of software modules may provide the same operation. Operating software 407 may further include an operating system, utilities, drivers, network interfaces, applications, or some other type of software. When executed by processing circuitry 405, operating software 407 directs processing system 403 to operate computing system 400 as described herein. In particular, encryption module 408 encrypts and decrypts files being sent (e.g., between master host directory system 110 and each constituent host directory system 122).

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts. It is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a master host directory system for providing host directory synchronization and management in a computing environment, the method comprising:
receiving host data from each of a plurality of constituent host directory systems, wherein each constituent host directory system comprises a list of hosts connected to the computing environment, further wherein the host data comprises:
a name for each host; and
host connection information;
generating a master host list based on the received host data, wherein the master host list comprises a plurality of host data entries;
transmitting at least a portion of the master host list to a first constituent host directory system in the plurality of constituent host directory systems.

2. The method of claim 1 further comprising supplementing the master host list with supplemental host data, wherein the supplemental host data comprises at least one of the following:
a host identification token;
host metadata; or
host security data.

3. The method of claim 1 wherein the master host directory system receives the host data in host data files transmitted by the plurality of constituent host directory systems.

4. The method of claim 3 wherein the host data file is generated by each constituent host directory system by generating a local host list using a command line interface and formatting the local host list to permit mapping of data relating to lists, associative arrays, scalars and hierarchical data representations.

5. The method of claim 3 wherein the host data files are encrypted.

6. The method of claim 1 wherein the host data further comprises layer information, further wherein the master host list incorporates the layer information.

7. The method of claim 1 further comprising updating the master host list, wherein each host data entry in the master host list comprises an attribute that is updated each time the host data entry is modified.

8. The method of claim 7 wherein the attribute comprises a timestamp.

9. The method of claim 1 wherein each constituent host directory system further comprises host list structure data, and further wherein the master host list incorporates the host list structure data.

10. A non-transitory computer readable storage medium having a host directory synchronization and management application stored thereon, the host directory synchronization and management application including instructions, which when executed by one or more processors of a computing system, cause the computing system to:
receive host data from each of a plurality of constituent host directory systems, wherein each constituent host directory system comprises a list of hosts connected to the computing environment, further wherein the host data comprises:
a name for each host; and
host connection information;
generate a master host list based on the received host data, wherein the master host list comprises a plurality of host data entries;
transmit at least a portion of the master host list to a first constituent host directory system in the plurality of constituent host directory systems.

11. The non-transitory computer readable storage medium of claim 10 further comprising supplementing the master host list with supplemental host data, wherein the supplemental host data comprises at least one of the following:
a host identification token;
host metadata; or
host security data.

12. The non-transitory computer readable storage medium of claim 10 wherein the master host directory system receives the host data in encrypted host data files transmitted by the plurality of constituent host directory systems.

13. The non-transitory computer readable storage medium of claim 12 wherein the host data file is generated by each constituent host directory system by generating a local host list using a command line interface and formatting the local host list to permit mapping of data relating to lists, associative arrays, scalars and hierarchical data representations.

14. The non-transitory computer readable storage medium of claim 10 wherein the host data further comprises layer information, further wherein the master host list incorporates the layer information.

15. The non-transitory computer readable storage medium of claim 10 further comprising updating the master host list, wherein each host data entry in the master host list comprises an attribute that is updated each time the host data entry is modified.

16. The non-transitory computer readable storage medium of claim 15 wherein the attribute comprises a timestamp.

17. The non-transitory computer readable storage medium of claim 10 wherein each constituent host directory system further comprises host list structure data, and further wherein the master host list incorporates the host list structure data.

18. A method of operating a master host directory system for providing host directory synchronization and management in a computing environment, the method comprising:
receiving encrypted host data files, wherein each host data file comprises host data from each of a plurality of constituent host directory systems, wherein each constituent host directory system comprises a list of hosts connected to the computing environment, further wherein the host data comprises:
a name for each host;
host list structure data;
host connection information; and
layer information;
generating a master host list based on the received host data, wherein the master host list comprises a plurality of host data entries, wherein each host data entry comprises a timestamp that is updated each time the host data entry is modified;
transmitting at least a portion of the master host list to a first constituent host directory system in the plurality of constituent host directory systems.

19. The method of claim 18 further comprising supplementing the master host list with supplemental host data, wherein the supplemental host data comprises the following:
a host identification token;
host metadata; and
host security data.

20. The method of claim 18 wherein the host data file is generated by each constituent host directory system by generating a local host list using a command line interface and formatting the local host list to permit mapping of data relating to lists, associative arrays, scalars and hierarchical data representations.
